(19) United States
(12) Patent Application Publication
(10) Pub. No.: US 2008/0232966 A1
(43) Pub. Date: Sep. 25, 2008

(54) Detachable blade assembly for horizontal-axis wind turbine

(76) Inventors: Wen-Chang Wang, Tainan Hsien (TW); Yu-Ching Wang, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/726,042

(22) Filed: Mar. 20, 2007

(51) Int. Cl. B64C 11/28

(52) U.S. Cl. 416/142; 416/232

(57) ABSTRACT

A blade assembly for a horizontal-axis wind turbine includes a hub, and a plurality of detachable blade units each mounted on a periphery of the hub and each including a plurality of blades detachably connected with each other by a plurality of connecting devices. Thus, the blade assembly comprises a hub and a plurality of detachable blade units so that all parts of the blade assembly are detachable to reduce the whole volume of the blade assembly before assembly, thereby facilitating packaging, storage and transportation of the blade assembly.

### BACKGROUND OF THE INVENTION

1. Field of the Invention

The present invention relates to a blade assembly and, more particularly, to a blade assembly for a horizontal-axis wind turbine.

2. Description of the Related Art

A conventional horizontal-axis wind turbine comprises a hub and a plurality of blades each mounted on a periphery of the hub. Each of the blades is made of glass fiber material and has a hollow inside to reduced its whole weight. However, each the blades has a greater length, thereby causing inconvenience in packaging, storage and transportation of the blades. In addition, each of the blades is formed by coating a larger number of glass fibers, thereby increasing the costs of fabrication and wasting the making time.

### BRIEF SUMMARY OF THE INVENTION

In accordance with the present invention, there is provided a blade assembly, comprising a hub, and a plurality of detachable blade units each mounted on a periphery of the hub and each including a plurality of blades detachably connected with each other by a plurality of connecting devices.

The primary objective of the present invention is to provide a detachable blade assembly for a horizontal-axis wind turbine.

Another objective of the present invention is to provide a blade assembly, wherein the blade assembly comprises a hub and a plurality of detachable blade units so that all parts of the blade assembly are detachable to reduce the whole volume of the blade assembly before assembly, thereby facilitating packaging, storage and transportation of the blade assembly.

A further objective of the present invention is to provide a blade assembly, wherein each of the blades of each of the blade units is formed by a staged air blowing process so that each of the blades of each of the blade units is made easily and quickly, thereby decreasing the costs of fabrication.

A further objective of the present invention is to provide a blade assembly, wherein each of the pads is integrally formed with the through bores (or the screw bores) aligning with the respective through holes of the blades, and each of the connecting plates is integrally formed with the fixing holes aligning with the respective through holes of the blades, so that the blades are combined together easily and quickly, thereby enhancing the working efficiency of assembling the blade assembly.

A further objective of the present invention is to provide a blade assembly, wherein the blades are assembled and disassembled by rotating the fastening members by a hand tool without having to use a heavy machine, thereby greatly facilitating a user assembling and disassembling the blade assembly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially top view of a blade assembly in accordance with the preferred embodiment of the present invention.

FIG. 2 is a partially exploded perspective view of the blade assembly in accordance with the preferred embodiment of the present invention.

FIG. 3 is a side cross-sectional assembly view of the blade assembly as shown in FIG. 2.

FIG. 4 is a partially exploded perspective view of the blade assembly in accordance with another preferred embodiment of the present invention.

FIG. 5 is a side cross-sectional assembly view of the blade assembly as shown in FIG. 4.

### DETAILED DESCRIPTION OF THE INVENTION

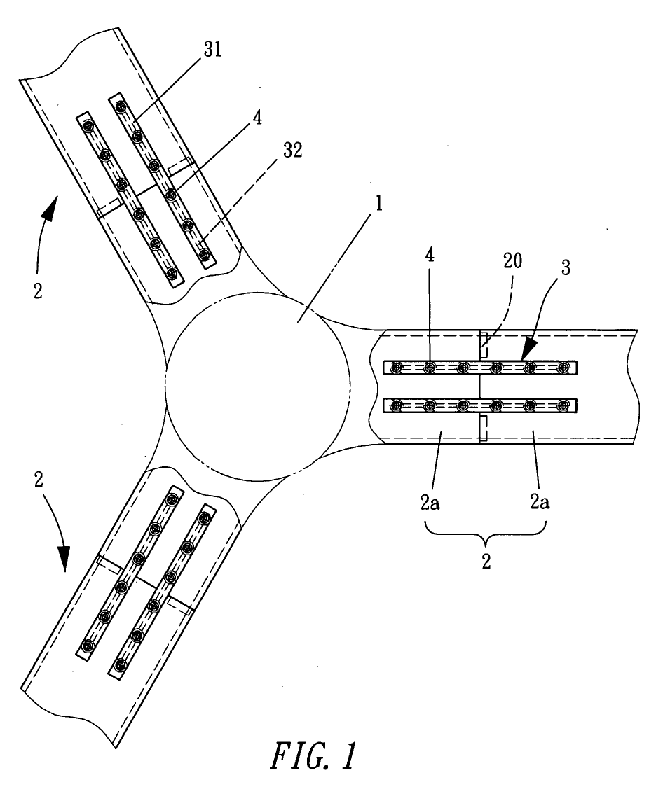

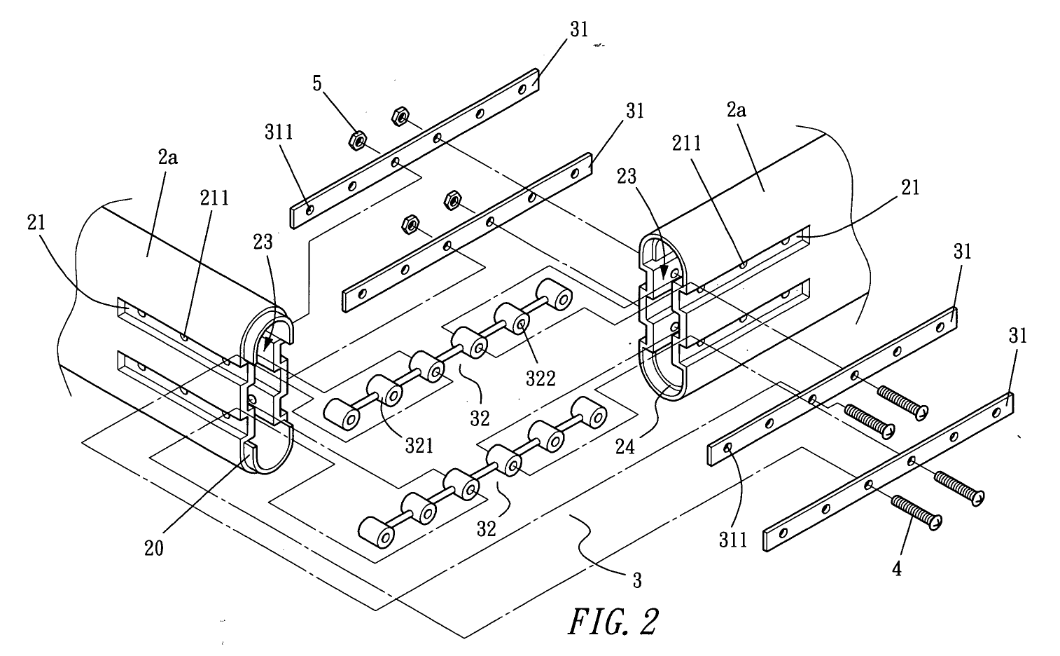

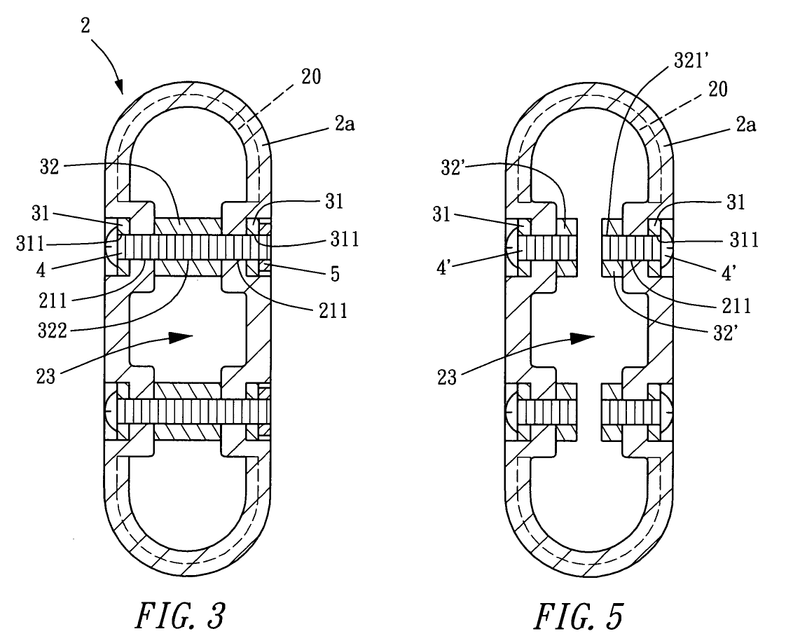

Referring to the drawings and initially to FIGS. 1-3, a blade assembly for a wind turbine, such as a horizontal-axis wind turbine, in accordance with the preferred embodiment of the present invention comprises a hub 1, and a plurality of detachable blade units 2 each mounted on a periphery of the hub 1 and each including a plurality of blades 2a detachably connected with each other by a plurality of connecting devices 3.

Each of the blades 2a of each of the blade units 2 has a hollow inside formed with a receiving space 23. Each of the blades 2a of each of the blade units 2 is made of plastic material (such as engineering plastics) having a greater tensile resistant feature and is formed by a staged air blowing process. Any two of the blades 2a of each of the blade units 2 are juxtaposed to each other, wherein a first one of the blades 2a of each of the blade units 2 has one end formed with a fixing groove 24, and a second one of the blades 2a of each of the blade units 2 has one end formed with an outwardly protruding fixing rib 20 inserted into the fixing groove 24 of the first one of the blades 2a of each of the blade units 2. Each of the blades 2a of each of the blade units 2 has two opposite side walls each formed with a plurality of elongated positioning slots 21. The positioning slots 21 of any two of the blades 2a of each of the blade units 2 align with each other. Each of the positioning slots 21 of each of the blades 2a is formed with a plurality of circular through holes 211 each connected to the receiving space 23. The positioning slots 21 of the two opposite side walls of each of the blades 2a align with each other, and the through holes 211 of the two opposite side walls of each of the blades 2a align with each other.

Each of the connecting devices 3 is mounted between any two of the blades 2a of each of the blade units 2 and includes a plurality of elongated connecting plates 31 mounted in the respective positioning slots 21 of any two of the blades 2a, a plurality of pads 32 mounted in the respective receiving spaces 23 of any two of the blades 2a and aligning with the respective connecting plates 31, and a plurality of fastening members extended through the respective connecting plates 31, any two of the blades 2a and the respective pads 32 to combine any two of the blades 2a together.

Each of the connecting plates 31 of each of the connecting devices 3 is formed with a plurality of circular fixing holes 311 aligning with the respective through holes 211 of any two of the blades 2a.

Each of the pads 32 of each of the connecting devices 3 includes a plurality of cylinders 321 each formed with a circular through bore 322, and the through bores 322 of each of the pads 32 align with the respective through holes 211 of any two of the blades 2a. The cylinders 321 of each of the pads 32 are connected with and spaced from each other. Each of the cylinders 321 of each of the pads 32 is made of plastic material.

In the preferred embodiment of the present invention, each of the fastening members of each of the connecting devices 3 includes a locking bolt 4 and a locking nut 5. The fastening members of each of the connecting devices 3 are extended through the fixing holes 311 of the respective connecting plates 31, the respective through holes 211 of any two of the blades 2a and the through bores 322 of the cylinders 321 of the respective pads 32.

In assembly, one ends of the pads 32 of each of the connecting devices 3 are initially inserted into the respective receiving spaces 23 of a first one of the blades 2a. Then, the other one ends of the pads 32 of each of the connecting devices 3 are inserted into the respective receiving spaces 23 of a second one of the blades 2a, and the fixing rib 20 of the second one of the blades 2a is inserted into the fixing groove 24 of the first one of the blades 2a so that any two of the blades 2a are juxtaposed to each other. Then, the connecting plates 31 of each of the connecting devices 3 are mounted in the respective positioning slots 21 of any two of the blades 2a. Finally, the fastening members of each of the connecting devices 3 are extended through the fixing holes 311 of the respective connecting plates 31, the respective through holes 211 of any two of the blades 2a and the through bores 322 of the cylinders 321 of the respective pads 32 to combine any two of the blades 2a together. The above-mentioned procedures are repeated successively, so that a plurality of blades 2a are combined together to form each of the blade units 2.

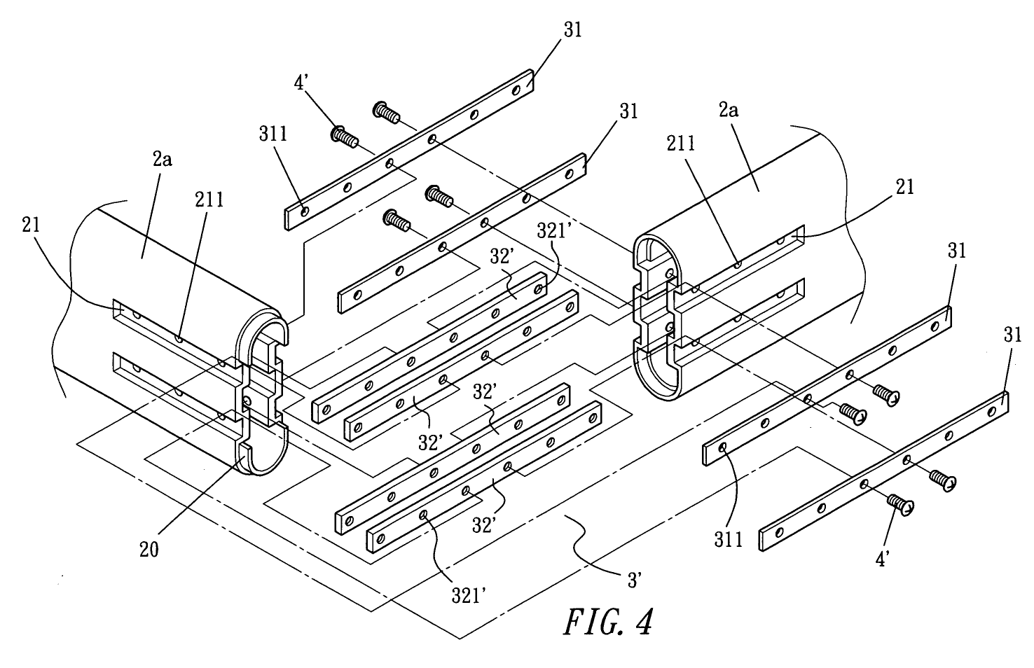

Referring to FIGS. 4 and 5, each of the pads 32′ of each of the connecting devices 3′ is an elongated sheet plate made of metallic material. Each of the pads 32′ of each of the connecting devices 3′ is formed with a plurality of screw bores 321′, and the screw bores 321′ of each of the pads 32′ align with the respective through holes 211 of any two of the blades 2a.

In the preferred embodiment of the present invention, each of the fastening members of each of the connecting devices 3′ includes a locking bolt 4′. The fastening members of each of the connecting devices 3′ are extended through the fixing holes 311 of the respective connecting plates 31 and the respective through holes 211 of any two of the blades 2a, and screwed into the screw bores 321′ of the respective pads 32′.

In assembly, one ends of the pads 32 of each of the connecting devices 3 are initially inserted into the respective receiving spaces 23 of a first one of the blades 2a, and one ends of the connecting plates 31 of each of the connecting devices 3 are inserted into the respective positioning slots 21 of the first one of the blades 2a. Then, the fastening members of each of the connecting devices 3′ are extended through the fixing holes 311 of one ends of the respective connecting plates 31 and the respective through holes 211 of the first one of the blades 2a, and screwed into the screw bores 321′ of one ends of the respective pads 32′. Then, a second one of the blades 2a is movable toward the first one of the blades 2a so that the other ends of the pads 32 of each of the connecting devices 3 are inserted into the respective receiving spaces 23 of the second one of the blades 2a, the other ends of the connecting plates 31 of each of the connecting devices 3 are inserted into the respective positioning slots 21 of the second one of the blades 2a, and the fixing rib 20 of the second one of the blades 2a is inserted into the fixing groove 24 of the first one of the blades 2a so that any two of the blades 2a are juxtaposed to each other. Then, the fastening members of each of the connecting devices 3′ are extended through the fixing holes 311 of the other ends of the respective connecting plates 31 and the respective through holes 211 of the second one of the blades 2a, and screwed into the screw bores 321′ of the other ends of the respective pads 32′ to combine any two of the blades 2a together. The above-mentioned procedures are repeated successively, so that a plurality of blades 2a are combined together to form each of the blade units 2.

Accordingly, the blade assembly comprises a hub 1, and a plurality of detachable blade units 2 so that all parts of the blade assembly are detachable to reduce the whole volume of the blade assembly before assembly, thereby facilitating packaging, storage and transportation of the blade assembly. In addition, each of the blades 2a of each of the blade units 2 is formed by a staged air blowing process so that each of the blades 2a of each of the blade units 2 is made easily and quickly, thereby decreasing the costs of fabrication. Further, each of the pads is integrally formed with the through bores 322 (or the screw bores 321′) aligning with the respective through holes 211 of the blades 2a, and each of the connecting plates 31 is integrally formed with the fixing holes 311 aligning with the respective through holes 211 of the blades 2a, so that the blades 2a are combined together easily and quickly, thereby enhancing the working efficiency of assembling the blade assembly. Further, the blades 2a are assembled and disassembled by rotating the fastening members by a hand tool without having to use a heavy machine, thereby greatly facilitating a user assembling and disassembling the blade assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A blade assembly, comprising:
a hub;
a plurality of detachable blade units each mounted on a periphery of the hub and each including a plurality of blades detachably connected with each other by a plurality of connecting devices.

2. The blade assembly in accordance with claim 1, wherein:
each of the blades of each of the blade units has a hollow inside formed with a receiving space;
each of the blades of each of the blade units has two opposite side walls each formed with a plurality of elongated positioning slots;
each of the connecting devices is mounted between any two of the blades of each of the blade units and includes a plurality of elongated connecting plates mounted in the respective positioning slots of any two of the blades, a plurality of pads mounted in the respective receiving spaces of any two of the blades and aligning with the respective connecting plates, and a plurality of fastening members extended through the respective connecting plates, any two of the blades and the respective pads to combine any two of the blades together.

3. The blade assembly in accordance with claim 2, wherein:
each of the positioning slots of each of the blades is formed with a plurality of through holes each connected to the receiving space;
each of the connecting plates of each of the connecting devices is formed with a plurality of fixing holes aligning with the respective through holes of any two of the blades;
each of the pads of each of the connecting devices includes a plurality of cylinders each formed with a circular through bore;
the fastening members of each of the connecting devices are extended through the fixing holes of the respective connecting plates, the respective through holes of any two of the blades and the through bores of the cylinders of the respective pads.

4. The blade assembly in accordance with claim 3, wherein each of the fastening members of each of the connecting devices includes a locking bolt and a locking nut.

5. The blade assembly in accordance with claim 1, wherein each of the blades of each of the blade units is made of plastic material and is formed by a staged air blowing process.

6. The blade assembly in accordance with claim 1, wherein:
any two of the blades of each of the blade units are juxtaposed to each other;
a first one of the blades of each of the blade units has one end formed with a fixing groove;
a second one of the blades of each of the blade units has one end formed with an outwardly protruding fixing rib inserted into the fixing groove of the first one of the blades of each of the blade units.

7. The blade assembly in accordance with claim 2, wherein the positioning slots of any two of the blades of each of the blade units align with each other.

8. The blade assembly in accordance with claim 3, wherein the positioning slots of the two opposite side walls of each of the blades align with each other, and the through holes of the two opposite side walls of each of the blades align with each other.

9. The blade assembly in accordance with claim 3, wherein the through bores of each of the pads align with the respective through holes of any two of the blades.

10. The blade assembly in accordance with claim 2, wherein the cylinders of each of the pads are connected with and spaced from each other.

11. The blade assembly in accordance with claim 2, wherein each of the cylinders of each of the pads is made of plastic material.

12. The blade assembly in accordance with claim 2, wherein each of the pads of each of the connecting devices is an elongated sheet plate made of metallic material.

13. The blade assembly in accordance with claim 2, wherein:
each of the positioning slots of each of the blades is formed with a plurality of through holes each connected to the receiving space;
each of the connecting plates of each of the connecting devices is formed with a plurality of fixing holes aligning with the respective through holes of any two of the blades;
each of the pads of each of the connecting devices is formed with a plurality of screw bores;
the fastening members of each of the connecting devices are extended through the fixing holes of the respective connecting plates and the respective through holes of any two of the blades, and screwed into the screw bores of the respective pads.

14. The blade assembly in accordance with claim 13, wherein the screw bores of each of the pads align with the respective through holes of any two of the blades.

15. The blade assembly in accordance with claim 13, wherein each of the fastening members of each of the connecting devices includes a locking bolt.
